(19) United States
(12) Patent Application Publication
(10) Pub. No.: US 2011/0202395 A1
(43) Pub. Date: Aug. 18, 2011

(54) SYSTEMS AND METHODS FOR UNIFIED LOYALTY MERCHANT REWARDS

(76) Inventors: Tim Swan, JR., Hilliard, OH (US); Brian L. Mott, Woodstock, GA (US)

(21) Appl. No.: 13/028,354

(22) Filed: Feb. 16, 2011

Related U.S. Application Data
(60) Provisional application No. 61/305,639, filed on Feb. 18, 2010.

(51) Int. Cl. G06Q 30/00

(52) U.S. Cl. 705/14.3

(57) ABSTRACT

The present invention provides a single payment and rewards card (or device) which can be used to purchase goods/services from a large variety of participating merchants. According to one aspect of the invention, card or device is arranged to earn and redeem different kinds of rewards points. For example, the single card/device can be used to earn airline miles from a participating airline and also grocery store rewards from participating grocery stores. It can also be arranged to obtain different kinds of rewards simultaneously. For example, when purchasing merchandise from a merchant, the card/device can be enabled to earn three different kinds of rewards: from the merchant, from the manufacturer of the merchandise, and from the financial institution that issued the card/device. All of the rewards can be subject to different rules, each set of rules imposed by the entity granting the rewards.

### CROSS-REFERENCE TO RELATED APPLICATIONS

This application claims benefits from U.S. Provisional Patent Application No. 61/305,639, filed Feb. 18, 2010, the contents of which are hereby incorporated herein by reference.

### BACKGROUND OF THE INVENTION

1. Field of the Invention

This invention relates broadly to systems and methods for merchants to reward customers. More particularly, this invention relates to unified systems and methods for merchants to reward customers

2. State of the Art

All businesses want to keep their customers loyal and over the years various systems have been devised to reward customers with incentives. One notorious system is “airline miles” which a passenger accumulates each time they fly on the airline and which can be redeemed for free tickets or class upgrades. Another popular system is credit card points. The customer typically receives one point for every dollar spent using the credit/charge card. The points are usually redeemable for products in a catalog published by the credit/charge card issuing company. Grocery stores also issue cards which are scanned every time the customer purchases items. Grocery store rewards typically involve instant discounts at checkout and/or coupons to be redeemed when you return to buy the same or similar items. Subject to certain privacy concerns, the rewarding merchant or financial institution can monitor your purchasing habits and customize rewards offered to you as the grocery stores the coupons offered. In some cases, a credit/charge card reward system may permit redeeming reward points at selected merchants.

There are several problems with the rewards systems currently in place. First, every reward system has its own card, thus requiring customers to carry many rewards cards or remember to take the correct card when they shop or travel. Second, in the few cases where a credit/charge card company allows its points to be redeemed at different merchants, it is the credit/charge card company who determines how reward points will be accumulated and how much they will be worth.

### SUMMARY OF THE INVENTION

The present invention provides a single payment and rewards card (or device) which can be used to purchase goods/services from a large variety of participating merchants. According to one aspect of the invention, card or device is arranged to earn and redeem different kinds of rewards points. For example, the single card/device can be used to earn airline miles from a participating airline and also grocery store rewards from participating grocery stores. It can also be arranged to obtain different kinds of rewards simultaneously. For example, when purchasing merchandise from a merchant, the card/device can be enabled to earn three different kinds of rewards: from the merchant, from the manufacturer of the merchandise, and from the financial institution that issued the card/device. All of the rewards can be subject to different rules, each set of rules imposed by the entity granting the rewards.

The card/device may be a normal credit or debit card, a “smart card”, a smart cell phone, a regular cell phone, an RFID chip or other secure device such as a device containing a nearfield communication chip for transmitting information to a point of sale terminal. The card/device may also be used to make online purchases and to make purchases from merchants who are not contracted with the rewards program.

The system can be managed by a card issuing financial institution or by an entity that contracts with a card entity financial institution. Merchants contract with the system manager. The merchants' point of sale terminals communicate with the system manager's servers either directly or via the merchants' servers via a telecommunication network (either public, private, or virtually private). In addition to processing the financial transaction, one or more servers keeps track of points earned and redeemed. Points can be redeemed at a merchant's point of sale terminal or online. Customers can view their accounts online via a website.

Exemplary processes for customers, merchants, and financial institutions participating in the program according to the invention are described in detail below.

### BRIEF DESCRIPTION OF THE DRAWINGS

FIG. 1 is a flow chart illustrating the process of a customer applying for a credit card/device according to the invention;

FIG. 2 is a flow chart illustrating the process of a customer applying for a debit card/device according to the invention;

FIG. 3 is a flow chart illustrating the process of a customer losing or forfeiting rights to use the card/device according to the invention;

FIGS. 4 and 5 is a flow chart illustrating the process of a customer choosing to shop at a participating online merchant according to the invention;

FIG. 6 is a flow chart illustrating the process of recruiting a financial institution to issue a card/device according to the invention;

FIG. 7 is a flow chart illustrating the process of a merchant introducing a new time saving benefit to specific customers card/device providing the ability to preorder, pay, earn and redeem rewards on commonly purchased goods and or services;

FIG. 8 is a flow chart illustrating how a participating merchant updates a customer's card/device giving the ability to preorder, pay, earn and redeem rewards on commonly purchased goods and or services; and

FIG. 9 is a schematic diagram of a system according to the invention.

### DETAILED DESCRIPTION

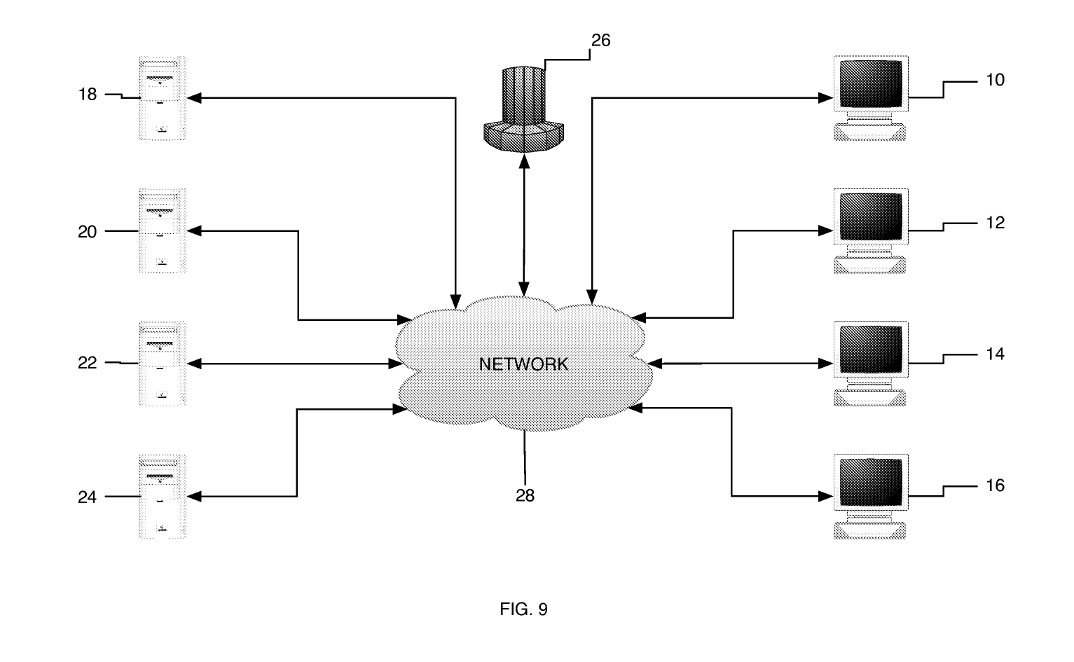

Turning first to FIG. 9, an exemplary system according to the invention includes a plurality of different merchant point of sale terminals, e.g. 10, 12, 14, 16, a plurality of different merchant servers, e.g. 18, 20, 22, 24, and a program administration server 26. All of these devices are coupled via a communications network 28. The network may be the public network, a private network, or a virtual private network. FIG. 9 is a simple illustration and it will be appreciated that many more terminals and servers are involved in carrying out the methods of the invention.

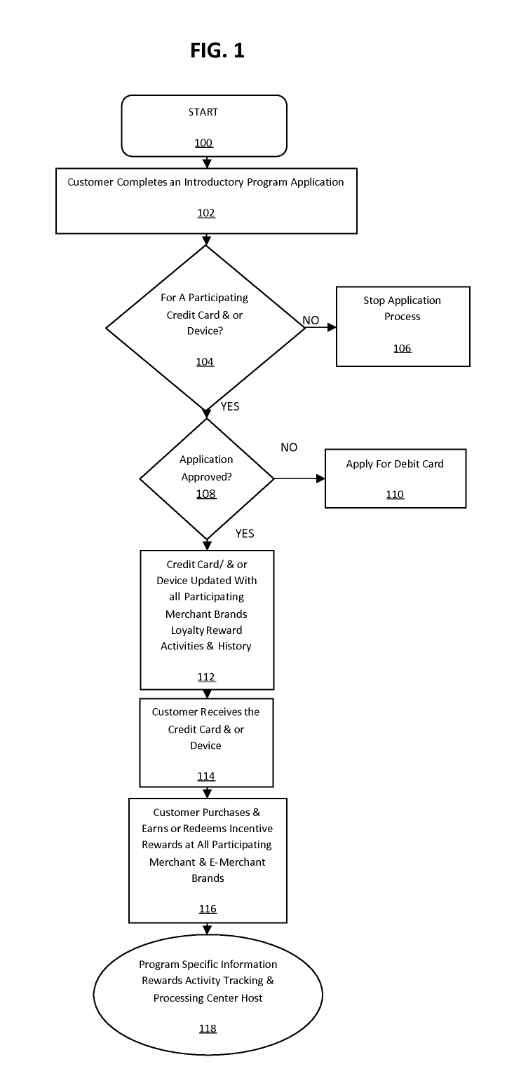

FIG. 1 provides a brief and general description of a customer applying for a credit card or device according to the invention. If the customer is approved, then the customer may begin purchasing, earning and redeeming incentive rewards at all participating merchants.

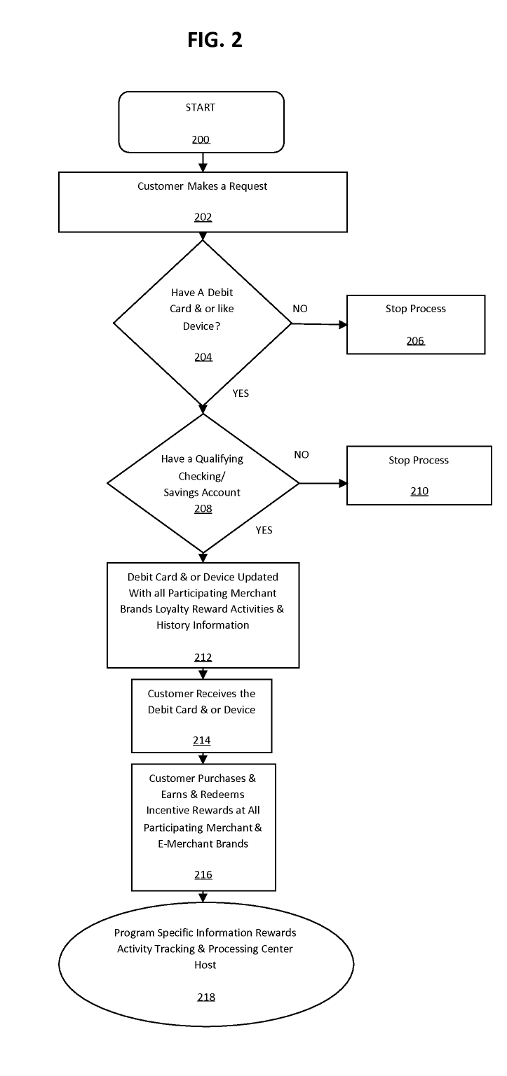

Step 100 begins the process of a customer completing the program's introductory application 102. Step 104 asks the customer if they are applying for the participating credit card/device. If the customer answers No in 106, then the application process stops (to be continued in FIG. 2). If the customer answers yes to the question in step 104, then the application is submitted. Step 108 determines whether the application been approved. If the answer is no, the credit card issuer will offer the customer an opportunity to apply for a debit card/device at 110.

If the application is approved, step 112 shows the credit card/device being updated with all participating merchant loyalty reward activities. Step 114 indicates the approved customer in step 112 receives the credit card/device from the issuer. Now the customer may proceed to step 116 and begin purchasing goods and services while earning and redeeming incentive rewards from all participating merchants. According to one aspect of the invention, the credit card/device may be used solely as a rewards earning device with payment made by another means or it may be used as both payment means and rewards earning means.

Step 118 illustrates that the program specific information of incentive rewards activities are tracked and maintained by the processing center host (e.g. server 26) in order to communicate those activities back and forth with the participating merchant servers (e.g. 18, 20, 22, 24) and those approved customers receiving their credit card/device. If the customer is approved, then the customer may begin purchasing, earning and redeeming incentive rewards at all participating merchants.

FIG. 2 provides a brief and general description of a customer requesting a debit card/device. If the customer is approved, then the customer may begin purchasing, earning and redeeming incentive rewards at all participating merchants.

Step 200 begins with the customer request 202 for a debit card/device. If the answer is no as determined at 204, in step 206, the process is stopped. If the answer is yes then it must be determined at 208 if the customer has a qualifying account. If the answer is no then the process stops at 210.

If the customer has a qualifying account, a card/device is issued and at 212 the card/device is updated with all participating merchant loyalty reward activities and past history information. At 214 the customer receives debit card/device for future use. In step 216 the customer(s) begin to purchase, earn and redeem incentive rewards at all participating merchants. The debit card/device may be used solely as a incentive rewards device and payment made by another means or it may be used as a means for payment and rewards. At 218 the program specific information of incentive rewards activities are tracked and maintained by the processing center host in order to communicate those activities back and forth with the participating merchants and those approved customers receiving their debit card/device.

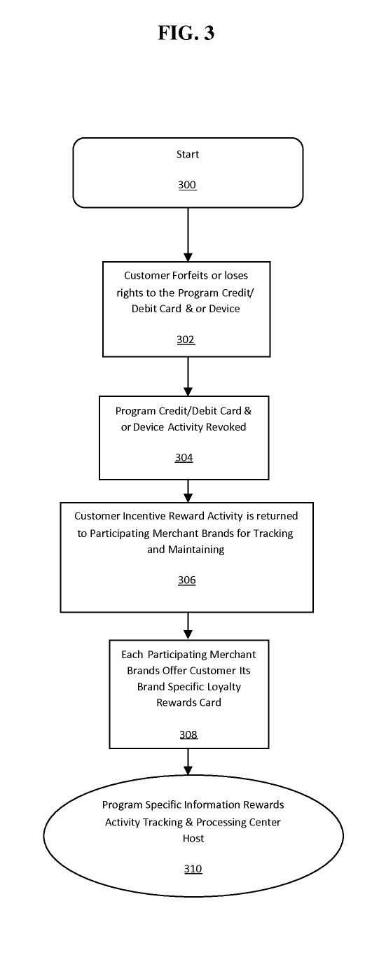

FIG. 3 provides a brief and general description of a process whereby the customer loses or forfeits the rights to use their credit/debit card/device.

Step 300 starts the process of a customer who loses or forfeits the right to use the issued card/device in 302. The rights to use are revoked is in step 304. At 306 all incentive rewards information is returned to the respective participating merchants for tracking and maintaining. Those respective merchants may offer their own loyalty reward card in step 308. Step 310 illustrates the information of incentive rewards activities to be tracked and maintained by the processing center host in order to communicate those activities back and forth with the participating merchants.

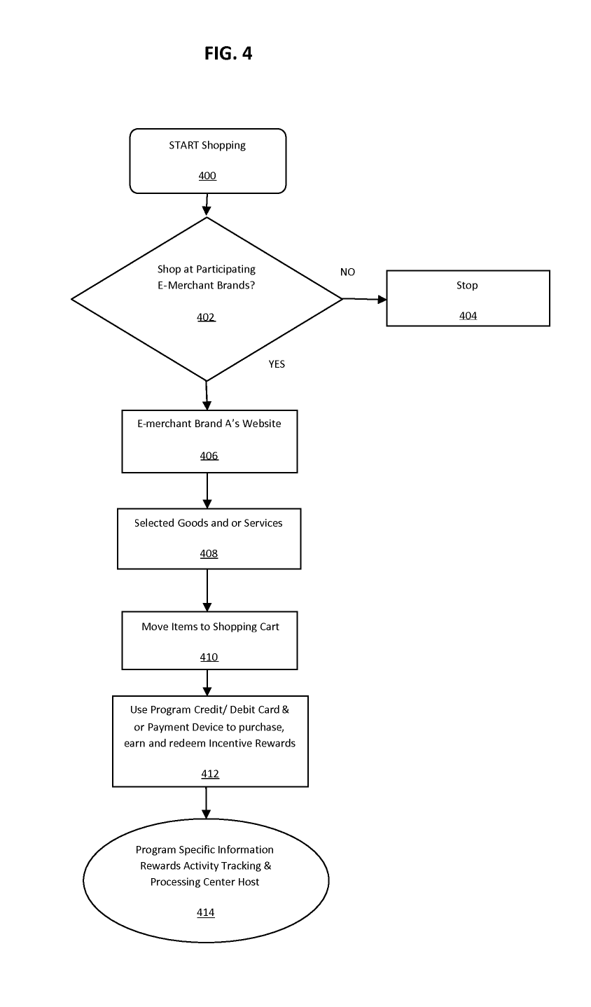

FIG. 4 provides a brief and general description of a customer choosing to shop at participating online merchants.

Step 400 starts shopping via the network. Step 402 determines whether the customer is selecting a participating merchant. If the answer is no, then the process stops at 404. Alternatively, though not illustrated, the card/device can be used at a non-participating merchant for the purpose of paying without receiving any rewards. If yes at 402, then the shopper proceeds to the participating merchant A's website at 406. At 408 the shopper selects the desired goods and or services. At 410 the shopper moves items to the shopping cart page. At 412 the shopper uses the card/device to purchase, earn and/or redeem incentive rewards resulting from the transaction. At 414 the information regarding incentive rewards activities are tracked and maintained by the processing center host in order to communicate those activities back and forth with the participating merchants and those approved customers receiving their card/device.

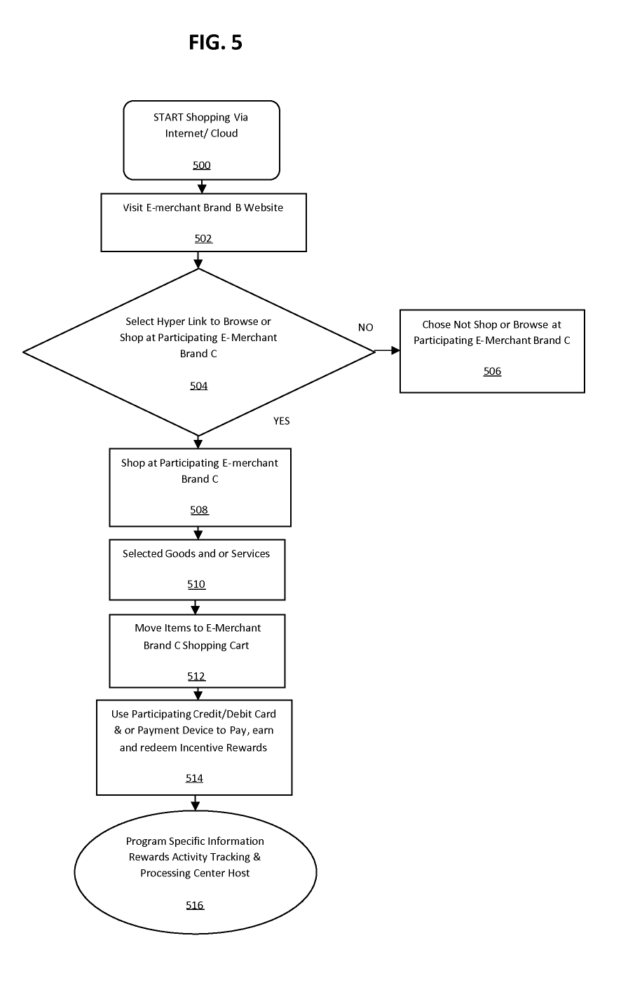

FIG. 5 provides a brief and general description of a customer choosing to shop at participating online merchant and choosing a hyperlink to visit and shop at another online merchant's website.

Step 500 starts the customer visit to the participating merchant B website at 502. At 504 it is determined whether the customer selects a hyper link for merchant C. At 506 if the answer is no, the customer does not choose the hyper link for merchant C. If the answer is yes, the customer chooses the hyper link in step 504 and step 508 begins to shop at another participating merchant C. At 510 the customer selects goods and or services and moves the items to the shopping cart page in step 512. At 514 the customer uses the card/device to purchase, earn and or redeem incentive rewards resulting from the transaction. At 516 the information regarding incentive rewards activities are tracked and maintained by the processing center host in order to communicate those activities back and forth with the participating merchants and those approved customers using their card/device.

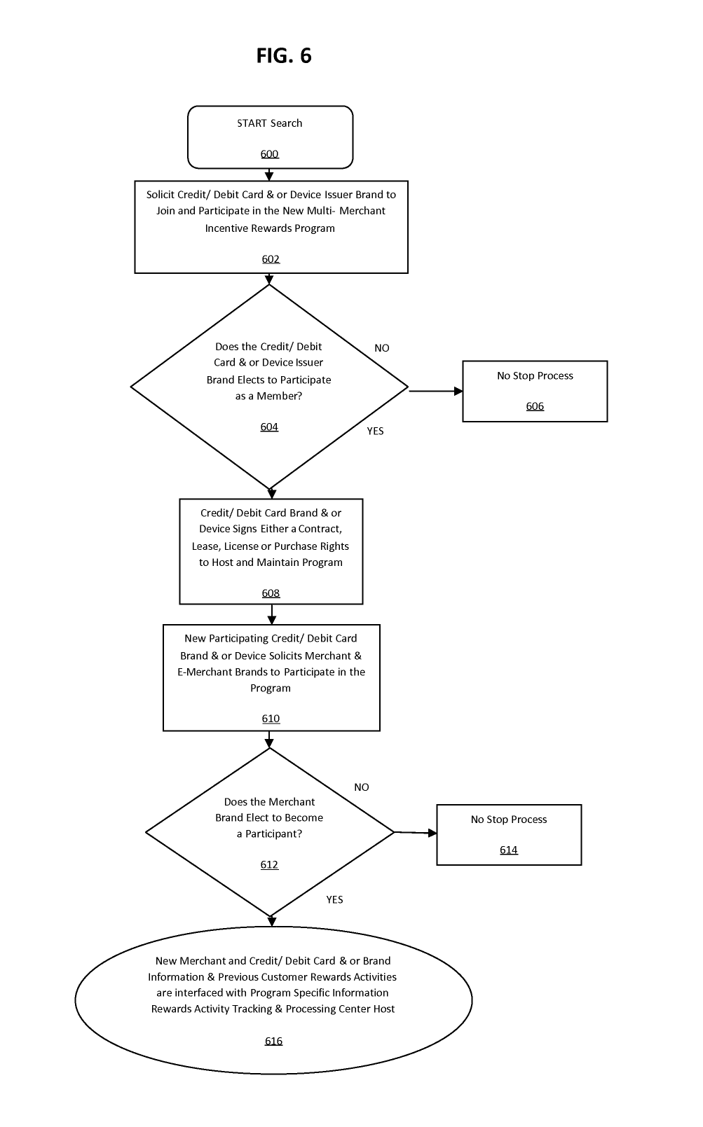

FIG. 6 provides a brief and general description of the process of searching for a card/device issuer to operate and maintain the systems and methods of the invention.

Step 600 starts a marketing search at 602 to solicit credit/debit card and or a like device issuers to join and participate in the new incentive rewards program. At 604 it is determined whether the issuer elects to participate in the program. If not the process stops at 606 with regard to that issuer. If the issuer elects to join, it will sign a lease, license or purchase the rights to host and maintain the program at 608. At 610 the new participating issuer will solicit merchants to participate in the new multi-merchant loyalty rewards program. At 612 it is determined whether a merchant has elected to become a participant. If the merchant does not elect, the process is stopped with regard to that merchant at 614. If the merchant elects answer is yes then at 616 the merchant provides information to participate as well as prior customer rewards activities for those customers as they become members and carry the new card/device which will be interfaced with the program specific Information rewards activity tracking and processing center host.

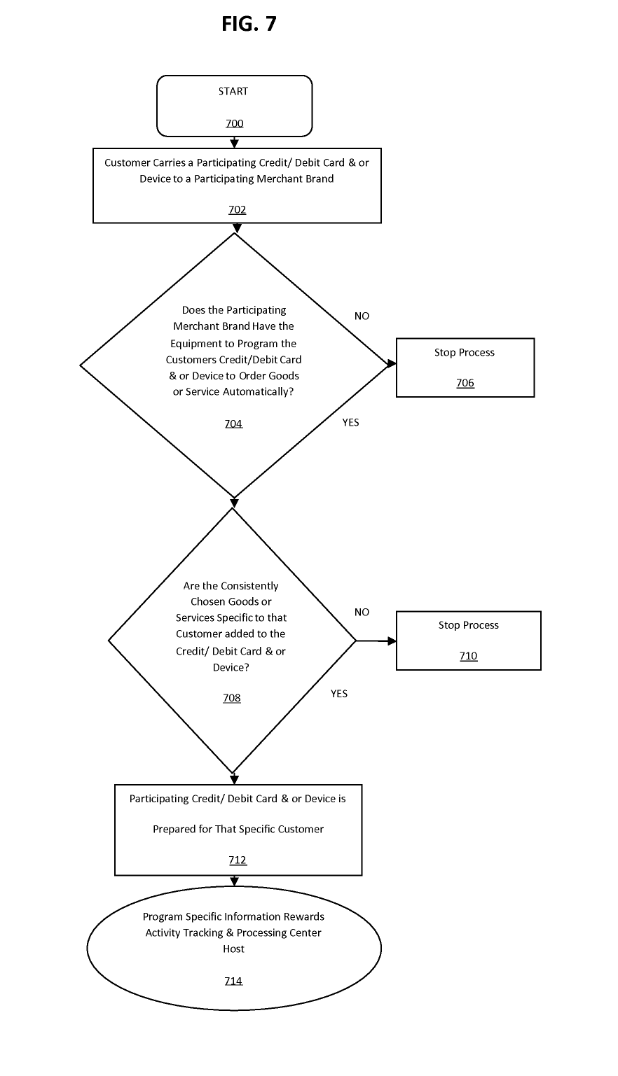

FIG. 7 provides a brief and general description of a benefit whereby a merchant has the ability to program customers' card/device to preorder, pay, earn and redeem rewards on frequently purchased goods and services.

At step 700 the customer carries their participating card/device to a participating merchant at 702. At 704 it is determined whether this participating merchant has the equipment at the point of sale to preorder goods and services commonly purchased on a time period basis e.g. a cup of coffee with cream ordered daily or whenever the patron visits. If the answer is no, then the process stops at 706. If yes it is determined at 708 whether this customer regularly orders the same goods or services. If not, the process stops at 710. If yes, the customer's card/device is processed for the repeat transactions at 712. The information is interfaced with the information rewards activity tracking & processing center host at 714.

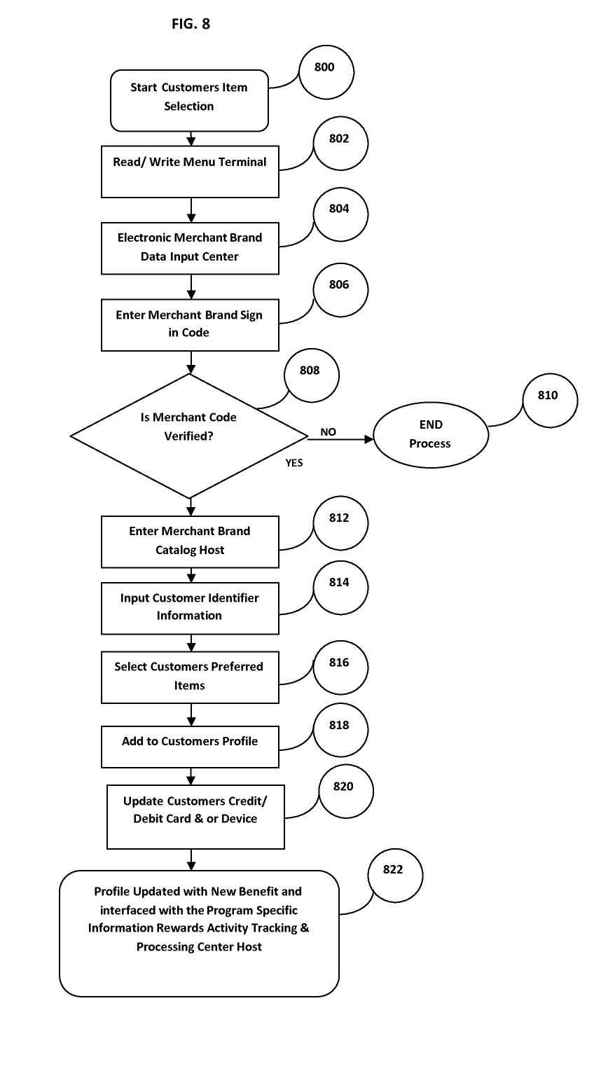

FIG. 8 provides a brief and general description whereby participating merchants may add and update a customer's card/device to preorder, pay, earn and redeem rewards on frequently purchased goods and services. This added benefit can be take place at the merchant's location and or website via the internet. It should be understood that when referring to updating the customer's card/device throughout herein, that also means, alternatively or in addition to updating the customer's account information in a database.

At 800 the customer begins the process of selecting preferred and frequently chosen items while patronizing a specific participating merchant. Step 802 is an example of using a read/write electronic device to enter the customer's desired request. The request data is input at 804. At 806 the merchant enters their respective sign in code. At 808 it is determined whether the merchant access code is verified? If NO the access process is stopped at 810. If YES the process continues to step 812 where the merchant is given access to their catalog via their server (e.g. 18, 20, 22, 24). At step 814 the participating customer's identification number is entered in order to proceed to step 816 where the customer's frequently preferred items are chosen and added to the customer's profile in step 818. Step 820 is an example of the customer's card/device being updated with the information from Step 816. Step 822 is an example of the customer's profile being updated with the new benefit added to their card/device. All associated activity is then interfaced with the program specific information rewards activity tracking and processing host and allows the customer to use their new benefit at the particular merchant.

There have been described and illustrated herein several embodiments of systems and methods for unified loyalty merchant rewards. It will therefore be appreciated by those skilled in the art that yet other modifications could be made to the provided invention without deviating from its spirit and scope as claimed.

What is claimed is:

1. A system for effecting payment for goods and services while also maintaining several different loyalty rewards accounts, comprising:
a plurality of point of sale terminals each associated with a different merchant, each merchant offering a different loyalty rewards program, each terminal being coupled to a communication network;
at least one server coupled to the communication network;
at least one customer card/device, wherein
when the customer card device is used to make a purchase at one of said terminals, the terminal communicates with the server, the sever completes the financial transaction and, either, maintains a database associating this customer with this rewards program, or transmits information to another server that maintains a database associating this customer with this rewards program.

2. A method for effecting payment for goods and services while also maintaining several different loyalty rewards accounts, comprising:
issuing a credit/debit card/device to a plurality of customers;
coupling a plurality of point of sale terminals to a communication network, each terminal associated with a different merchant having a different loyalty rewards program;
coupling a management server to the network, the server maintaining a database regarding the different rewards programs, such that when a customer presents their card/device at a terminal and purchases goods or services, the database associated with the rewards program associated with that terminal is updated.

3. The method according to claim 2, further comprising:
redeeming rewards by presenting the card/device at a terminal.

4. The method according to claim 2, wherein:
the card/device can be used to purchase goods or services from a merchant that does not have a rewards program.

5. The method according to claim 2, wherein:
The card/device can be presented at a terminal to earn rewards while using a separate payment method.
